(19) United States
(12) Patent Application Publication
(10) Pub. No.: US 2025/0200351 A1
(43) Pub. Date: Jun. 19, 2025

(54) METHOD AND APPARATUS FOR TRAINING A NEURAL NETWORK

(71) Applicant: Oxford University Innovation Limited, Oxford (GB)

(72) Inventors: James Spall, Oxfordshire (GB); Xianxin Guo, Oxfordshire (GB); Alexander Lvovsky, Oxfordshire (GB)

(21) Appl. No.: 18/846,780

(22) PCT Filed: Feb. 28, 2023
(86) PCT No.: PCT/GB2023/050441

§ 371 Date: Sep. 13, 2024

(30) Foreign Application Priority Data
Mar. 14, 2022 (GB) GB2203480.5

(51) Int. Cl. G06N 3/067; G06N 3/048; G06N 3/084

(52) U.S. Cl. CPC G06N 3/0675; G06N 3/048; G06N 3/084

(57) ABSTRACT

Methods and apparatus for training a neural network are disclosed. In one arrangement, a method comprises performing forward propagation of information through the neural network. An error backpropagation is performed to update parameters defining the neural network. A mathematically linear stage of the forward propagation is performed optically.

Machine learning powered by artificial neural networks has reshaped the landscape in many different areas over the last decade. This machine learning revolution is fuelled by the immense parallel computing power of electronic hardware such as graphics- and tensor-processing units. However, the rapid growth of computational demand in this field has outpaced Moore's law, and today's machine learning applications are associated with high energy cost and carbon footprint.

Optics provides a promising analog computing platform, and optical neural networks (ONNs) have recently been the focus of intense research and commercial interest. Thanks to the superposition and coherence properties of light, neurons in ONNs can be naturally connected via interference or diffraction in different settings, whilst the neuron activation function can be physically implemented with a large variety of nonlinear optical effects. Together these resources have enabled the optical realization of various neural network architectures, including fully connected, convolutional and recurrent.

Known advanced optical technologies have allowed ONNs to reach a computational speed of ten trillion operations per second, comparable to that of their electronic counterparts; and the energy consumption can be on a scale of, or even less than, one photon per operation, orders of magnitude lower than that of digital computation.

Existing ONNs are primarily developed to perform inference tasks in machine learning, and they are usually trained on a digital computer. During this in silico training, one has to simulate the physical system digitally, then apply the standard “backpropagation” algorithm as described in Y. LeCun, Y. Bengio, and G. Hinton, Nature 521, 436 (2015). The backpropagation algorithm involves repeated forward- and backward-propagation of information inside the network. The update of weight matrices is computed from the combined data obtained in these two processes. Because any physical system exhibits certain experimental imperfections that are hard to accurately model, ONNs trained in this way usually perform worse than expected. To narrow this reality gap, it is possible to incorporate simulated noise into the in silico training. This approach is however suboptimal because it does not incorporate the specific pattern of imperfections that is present in a given ONN.

L. G. Wright, T. Onodera, M. M. Stein, T. Wang, D. T. Schachter, Z. Hu, and P. L. McMahon, arXiv preprint arXiv:2104.13386 (2021) discloses “Physics-Aware Training” of various physical networks, including an opto-electronic network. In the described approach, the activation of the neurons in the forward propagation is implemented by means of optical nonlinearity, whereas both the linear portion of the forward propagation, as well as the entire backward propagation, is done electronically.

T. Zhou, X. Lin, J. Wu, Y. Chen, H. Xie, Y. Li, J. Fan, H. Wu, L. Fang, and Q. Dai, Nature Photonics 15, 367 (2021) discloses a methodology comprising, after training a 3-layer ONN in silico, tested the network optically, making corrections to the digital models of the second and third layers to account for the measured performance of the first layer, and digitally re-training these layers. The optical testing and re-training is then repeated just for the third layer. A shortcoming of this approach is that the physics of the third layer remains unaccounted for. Furthermore, the training must be repeated multiple times.

It is an object of the invention to provide alternative and/or improved ways of training neural networks.

According to an aspect of the invention, there is provided a method of training a neural network, comprising: performing a forward propagation of information through the neural network; and performing an error backpropagation to update parameters defining the neural network, wherein: a mathematically linear stage of the forward propagation is performed optically.

Embodiments are different from the disclosure of Wright et al. mentioned above because the neural networks involved in the training all contain optical linear layers. The computational advantages of ONNs reside in the optical linear layers, and experimental imperfections often originate from the optical linear connection. Including optical propagation through at least one linear layer thus enhances hybrid training.

Embodiments are different from the disclosure of Zhou et al. mentioned above at least because initial in silico training is not required, and the optical signal is used to compute every single update of the physical weight matrices. The inventors have furthermore analyzed the performance of the networks under the influence of various types of noise and find significant improvement in comparison to in silico training, at least when the noise is static, i.e. does not change in time.

Embodiments of the present disclosure provide an important step towards an arrangement in which a training signal is obtained directly from optical fields propagating through a neural network in both directions. Such a method would not only allow faster training, but also help close the reality gap in that the physics of the system, including its imperfections, would be built directly into the training.

The inventors demonstrate embodiments below that include three different ONNs: an optical linear classifier, a hybrid neural network with optical and electronic layers, and a complex-valued ONN. The inventors have furthermore demonstrated that the embodiments perform better than alternatives based on purely in silico modelling of ONNs in the presence of a range of different noise sources representing typically found imperfections in the optics.

In an embodiment, the optically performed linear stage of the forward propagation comprises a matrix-vector multiplication representing interconnection of neurons in different layers of the neural network. In an embodiment, the vector represents values of neurons in one layer of the neural network. The matrix represents a weight matrix defining weights associated with interconnections with another layer in the neural network, the weights forming at least a portion of the parameters to be updated by the error backpropagation. In an embodiment, the first spatial light modulator is controlled to provide a vector-modulating portion that represents the vector; the second spatial light modulator is controlled to provide a matrix-modulating portion that represents the weight matrix; and the beam of light is directed through the optical system in such a way as to be modulated by the vector-modulating portion of the first spatial light modulator and by the matrix-modulating portion of the second spatial light modulator. In an embodiment, an optical arrangement down-beam of the second spatial light modulator sums light from each part of the matrix-modulating portion representing a respective row of the weight matrix to provide light representing a respective element of an output vector. In an embodiment, the summing of light to provide light representing each element of the output vector includes summing of light from a reference beam that is directed through the optical system.

Summing of light from a reference beam may be used for example to perform homodyne detection. The reference beam may represent a local oscillator used in the homodyne detection. Since both the reference beam and the signal (representing each element of the output vector) share the same optical path their relative phase barely fluctuates. The phase offset can be conveniently set by the second spatial light modulator. This approach avoids the extra experimental complexity of introducing an external reference beam and actively stabilizing the relative phase.

In some embodiments, the first spatial light modulator is configured and/or controlled to provide a reference portion separate from the vector-modulating portion; the second spatial light modulator is configured and/or controlled to provide a reference portion separate from the matrix-modulating portion; and the reference beam interacts with the reference portions of the first and second spatial light modulators. This approach provides an efficient way of ensuring that the reference beam and the signal share the same optical path.

In an embodiment, the reference portion of the second spatial light modulator has a plurality of sub-portions, each sub-portion aligned with a part of the matrix-modulating portion corresponding to a respective row of the weight matrix; and each sub-portion comprises a plurality of sub-regions, each sub-region configured to apply a different phase offset to light interacting with the sub-region. This approach makes it possible to multiply each row by multiple different phases, thereby increasing the flexibility of calculations available.

In an embodiment, each plurality of phase-signals corresponding to a row of the weight matrix produces a corresponding plurality of intensities and the method comprises using those intensities to calculate the real and imaginary parts of a respective element of a complex vector representing a result of the matrix-vector multiplication. Thus, an efficient implementation of complex-valued linear stage is provided.

In an alternative aspect, there is provided an apparatus for training a neural network, comprising: a data processing system representing the neural network, wherein: the data processing system is configured to: perform a forward propagation of information through the neural network; and perform an error backpropagation to update parameters defining the neural network; and the data processing system includes an optical data processing unit configured to perform at least a mathematically linear stage of the forward propagation.

Embodiments of the disclosure will be further described by way of example only with reference to the accompanying drawings.

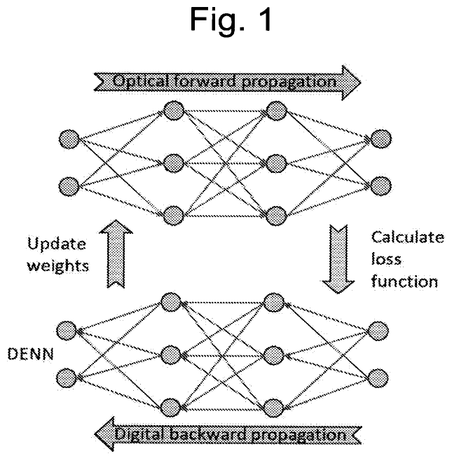

FIG. 1 is a conceptual illustration of a scheme for training a neural network in which forward propagation is implemented in an optical system and error backpropagation is implemented digitally.

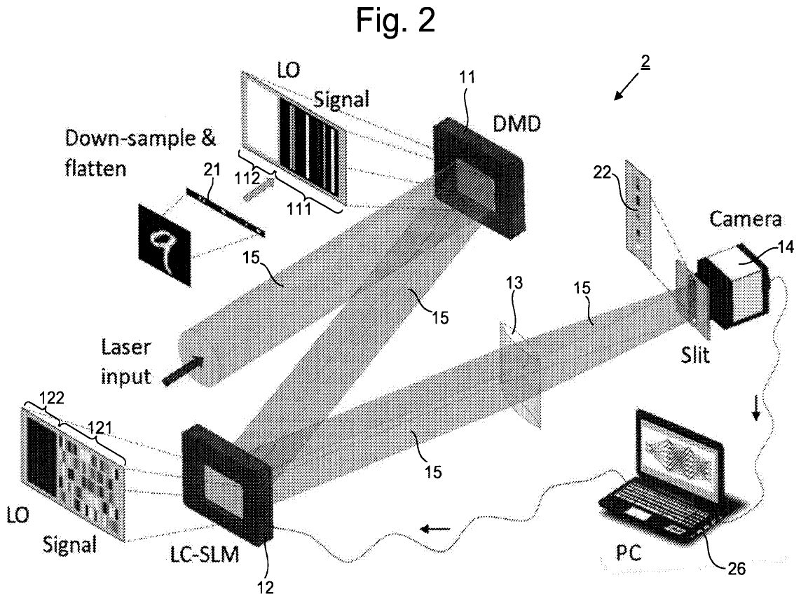

FIG. 2 is a schematic depiction of a single-layer optical multiplier for building an ONN.

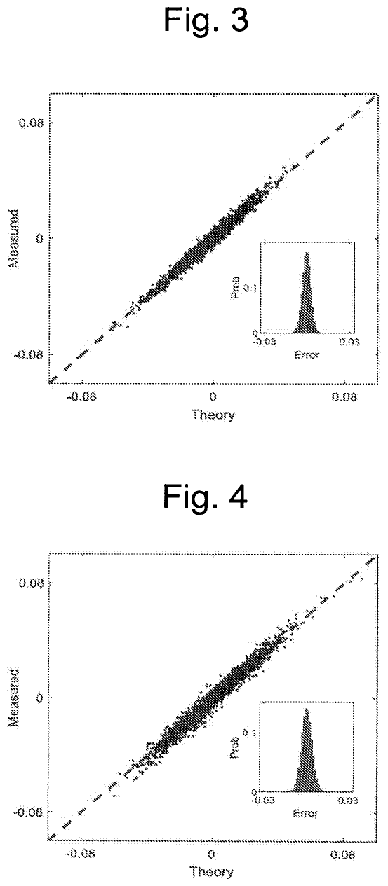

FIGS. 3 and 4 are graphs characterizing performance of optical multipliers according to the disclosure. The graphs depict performance of a real-valued optical matrix-vector multiplication with a matrix size of 100×10 (FIG. 3) and 100×25 (FIG. 4). The vertical axis represents measured values and the horizonal axis represents results expected by theory. Ideal results would fall along the dashed diagonal line. Distributions of the multiplication error are shown in insets. All the values are normalized by the maximum possible output.

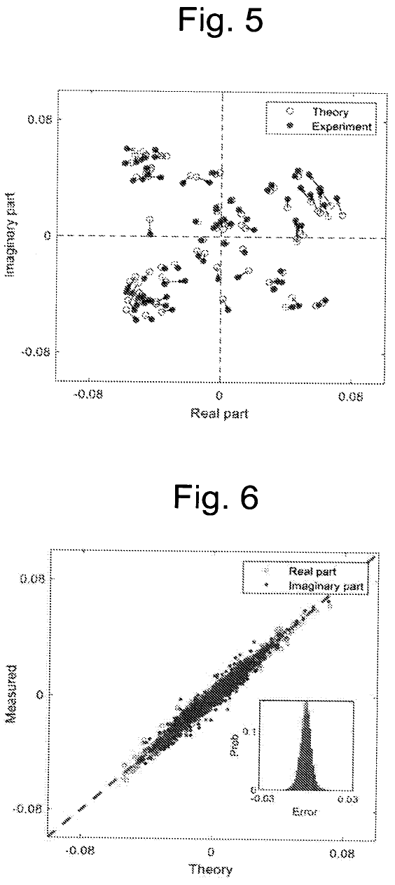

FIGS. 5 and 6 are further graphs characterizing performance of optical multipliers according to the disclosure. FIG. 5 depicts examples of complex-valued optical MVM output (solid circles) compared with theory targets (open circles) on the complex plane.

The differences are indicated by arrows. FIG. 6 is a graph showing performance of complex-valued optical MVM with matrix size of 100×10. Real and imaginary parts of the experimental result are shown in open circles and solid circles respectively.

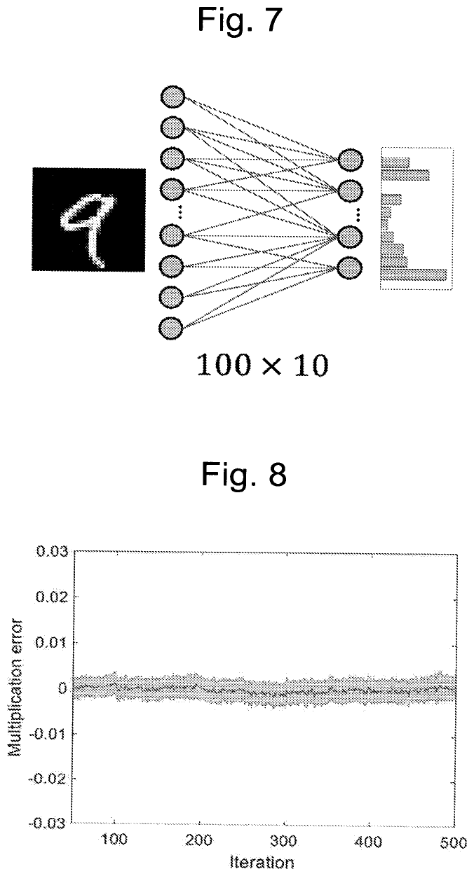

FIG. 7 schematically depicts a network architecture of an optical linear classifier referred to as ONN-1 implemented with 100 input neurons and 10 output neurons.

FIG. 8 is a graph depicting evolution of the optical MVM error during training of the ONN-1 depicted in FIG. 7.

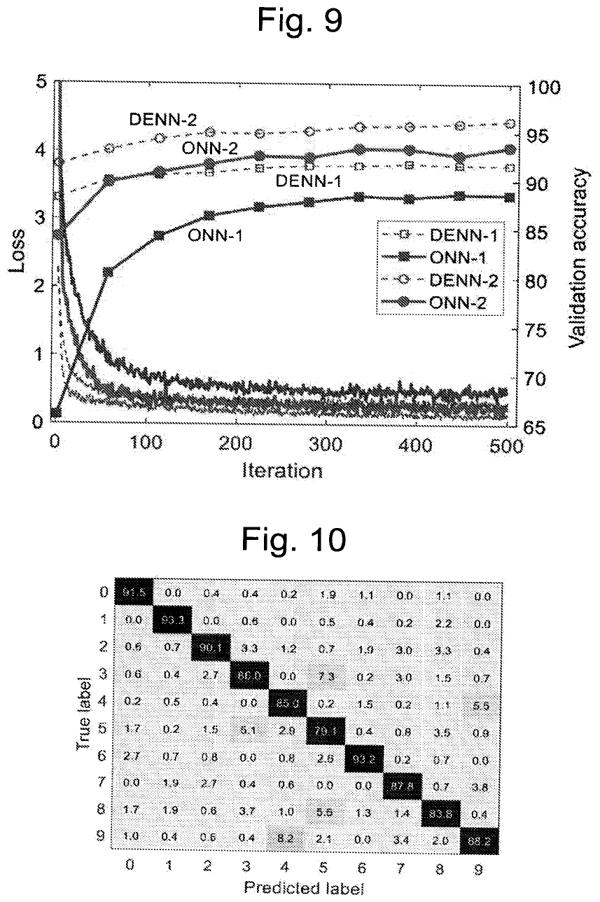

FIG. 9 depicts learning curves of hybrid trained ONNs compared with digital electronic neural networks (DENNs). The DENNs respectively have the same network architectures as the ONNs.

FIG. 10 is a confusion matrix of a test set for ONN-1.

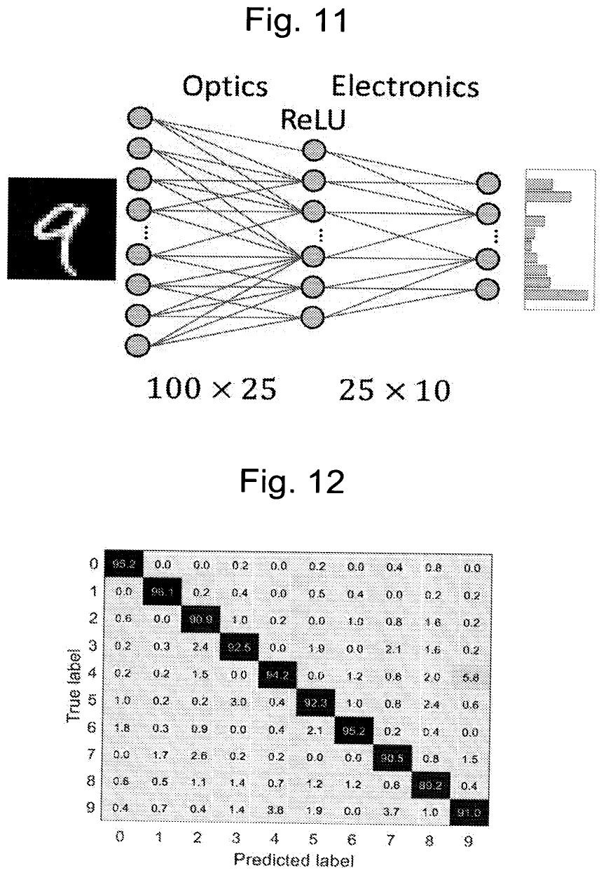

FIG. 11 schematically depicts a network architecture of a hybrid opto-electronic network referred to as ONN-2 and implemented with an optical layer, digital ReLU activation and a digital layer. The neuron numbers are 100, 25 and 10 for the input, hidden and output layer.

FIG. 12 is a confusion matrix of a test set for ONN-2.

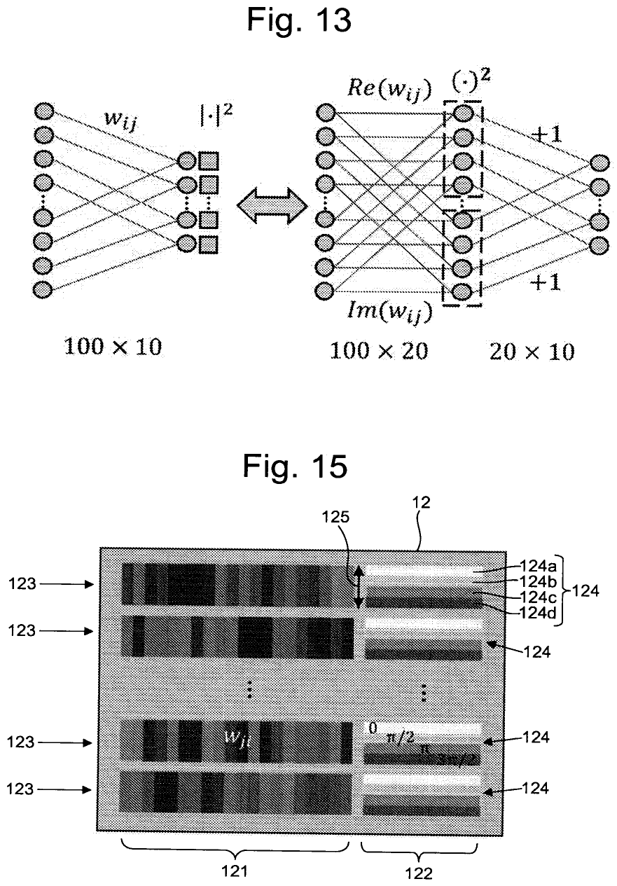

FIG. 13 schematically depicts a network architecture of a complex-value ONN referred to as ONN-3 (left) and the equivalent real-value ONN (right).

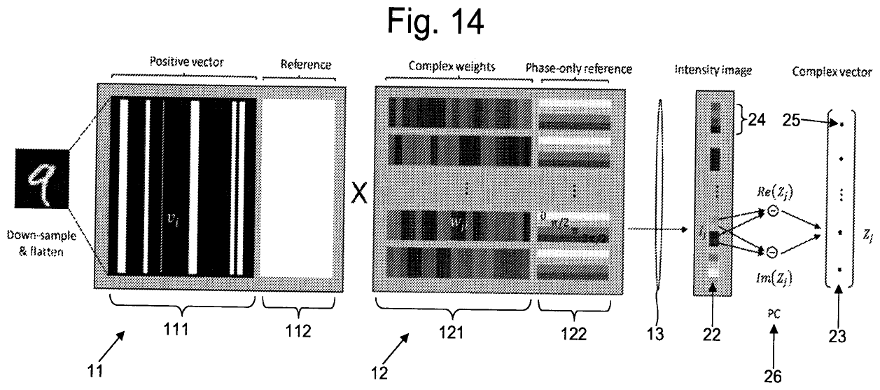

FIG. 14 depicts an optical encoding and complex-valued measurement scheme.

Positive vectors are encoded on a digital micromirror device (DMD). Complex-valued weights along with phase-only references are encoded on a liquid-crystal phase-only spatial light modulator (LC-SLM). At the output, intensities are measured and complex values digitally reconstructed.

FIG. 15 is an enlarged view of the LC-SLM of FIG. 14 to show labelling of example sub-portions of the LC-SLM implementing the phase-only references.

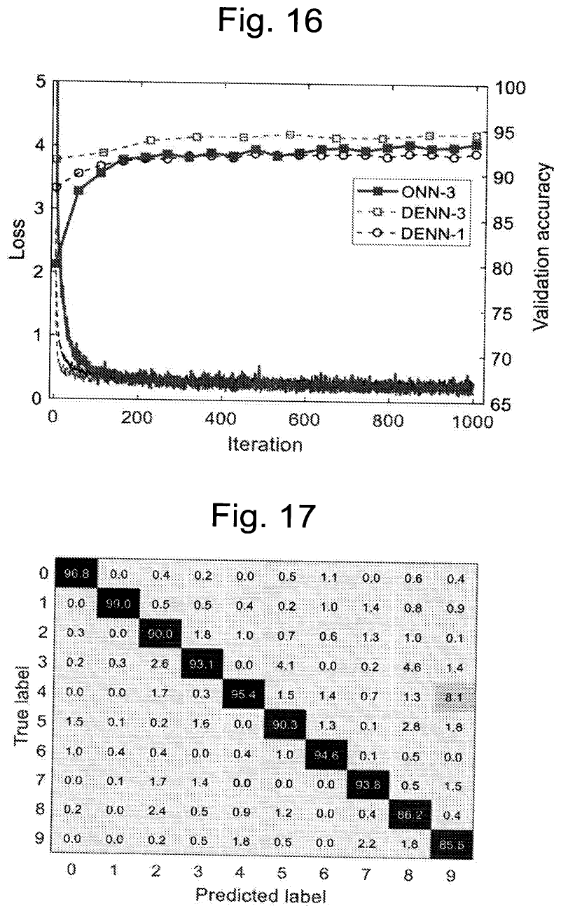

FIG. 16 depicts a learning curve of a hybrid trained optical neural network (ONN-3) compared with a digital electronic neural networks (DENN-3) having the same network architecture as ONN-3.

FIG. 17 is a confusion matrix of a test set for ONN-3.

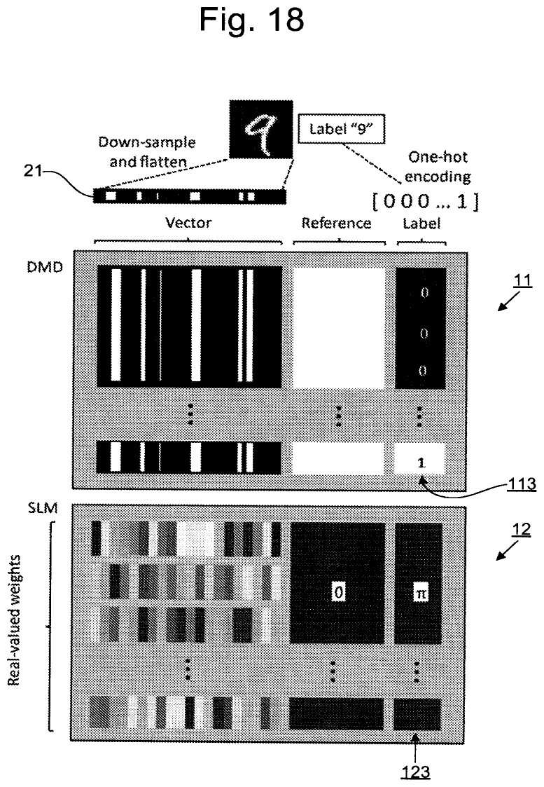

FIG. 18 depicts an encoding scheme for optical calculation of the error vector in ONN-1. The destructive interference between the label region and signal region yields the optical calculation of the error vector when an MSE loss function is used.

Embodiments of the present disclosure comprise methods of training a neural network and apparatus for performing the method. The apparatus may, for example, comprise a data processing system representing the neural network. The training of the neural network may be used to train an optical neural network (ONN). The neural network directly involved in the training methods described below may comprise all or a part of such an ONN. Thus, part of the ONN may be represented (or modelled) digitally and the digital representation (model) may be used in the training. Training that involves one or more optical elements and one or more digital elements (e.g., modelling optical elements) may be described as hybrid training. The data processing system may thus comprise an optical data processing unit for performing optical data processing steps and a computer for performing data processing steps in silico (digitally). Any of the embodiments described below may be used in such a hybrid training scenario.

In some embodiments, the method comprises performing forward propagation of information through the neural network. The method further comprises performing an error backpropagation to update parameters defining the neural network. The error backpropagation may be performed using the standard backpropagation algorithm mentioned in the introductory part of the description above. The parameters defining the neural network may comprise weight matrices, as described below. The method may comprise supervised learning.

In supervised learning of a neural network, weight matrices (parameters defining the neural network) may be iteratively updated via the backpropagation algorithm. This process may be referred to as training of the neural network. The updating of the weight matrices aims to enable the network to replicate a mapping between a network input and a ground true answer.

The training may be implemented using a labelled dataset (x, t), where x is sent to the network input (a)ᵢ⁽⁰⁾=xᵢ), and t is the label to be compared with the network output. The neurons in subsequent layers are interconnected as

$${z}_{j}^{( l )} = {\sum }_{i} {w}_{ji}^{( l )} {a}_{i}^{( l - 1 )} , \qquad ( 1 )$$

where (a)ⱼ^{(l)}=g(zⱼ^{(l)}) is the nonlinear activation of each neuron. A loss function, L, is defined in order to quantify the divergence between the network output and the correct label. Its gradient with respect to the weights is

$$\frac{\partial ℒ}{\partial {w}_{ji}^{( l )}} = \frac{\partial ℒ}{\partial {z}_{j}^{( l )}} \frac{\partial {z}_{j}^{( l )}}{\partial {w}_{ji}^{( l )}} = {δ}_{j}^{( l )} {a}_{i}^{( l - 1 )} , \qquad ( 2 )$$

where δⱼ^{(l)}≡∂ [symbol] /∂zⱼ^{l} is referred to as the “error” at the j-th neuron in the l-th layer. By applying the chain rule of calculus, the following is obtained:

$${\partial }_{j}^{( l )} = {\sum }_{k} \frac{\partial ℒ}{\partial {z}_{k}^{( l + 1 )}} \frac{\partial {z}_{k}^{( l + 1 )}}{\partial {z}_{j}^{( l )}} = {g}^{′} ( {z}_{j}^{( l )} ) {ρ}_{j}^{( l + 1 )} , \qquad ( 3 )$$

where ρⱼ^{(l+1)}=Σₖwₖⱼ^{(l+1)}δₖ^{(l+1)}. From (3) it can be seen that the error vector inside the network can be calculated from the error vector at the subsequent layer, and the error vector at the output layer is directly calculated from the loss function. Once these error vectors, as well as the activations a^{(l-1)} of all neurons are known, the gradients (2) of the loss function with respect to all the weights can be calculated, and hence the weights can be iteratively updated via gradient descent until convergence. This procedure is efficient in training digital electronic neural networks (DENNs). To train an ONN, one can model the network architecture on the computer, and implement the backpropagation algorithm digitally. The final weights after the training are then transferred to the ONN to perform inference tasks. This is called the in silico training method.

Embodiments of the present disclosure describe a hybrid training scheme in which training is performed partly in silico and partly optically. In some embodiments of this hybrid training scheme, at least a mathematically linear stage of the forward propagation is performed optically. In some embodiments, at least a portion of the error backpropagation is performed digitally (i.e., in silico, using a computer). In some embodiments, a non-linear stage of the forward propagation is performed digitally using a computer. The non-linear stage may, for example, comprise any one or more of the following: a Rectified Linear Unit (ReLU); a Leaky ReLU; an Exponential Linear Unit (ELU); a sigmoid activation function; a tanh activation function; a modulus squared activation function; or any other digital non-linear activation function. A further linear stage and/or non-linear stage of the forward propagation may be performed digitally using a computer.

As we see from Eq. (2), the gradient matrix in each layer is the outer product of the corresponding activation and error vectors. In some embodiments of the hybrid training scheme, the activation vectors are obtained through optical forward propagation of neuron values, as depicted in FIG. 1 (top). These values may be measured by photodetectors and recorded digitally. In the example depicted, the error vectors are obtained through digital backpropagation, as depicted in FIG. 1 (bottom). Once the weight gradients are calculated (e.g., via Eq. (2)), the physical weights of the ONNs are updated. This hybrid training process is repeated until convergence.

In a neural network, the interconnection of neurons (e.g., as represented by Eq. (1)) is achieved by matrix-vector multiplication (MVM), and this basic operation constitutes the major computational workload in machine learning. In embodiments of the present disclosure, at least a portion of this operation is performed optically (i.e. as an optically performed linear stage of the forward propagation). Thus, the optically performed linear stage of the forward propagation may comprise a matrix-vector multiplication representing interconnection of neurons in different layers of the neural network. The vector represents values of neurons in one layer (e.g., values aₗ^{(l-1)} for layer l−1) of the neural network. The matrix represents a weight matrix defining weights (e.g., wⱼᵢ^{(l)} in Eq. (1)) associated with interconnections with another layer (e.g., layer l) in the neural network. The weights form at least a portion of the parameters to be updated by the error backpropagation.

The optically performed linear stage may be implemented by an optical matrix-vector multiplier (MVM) 2. Thus, the optical data processing unit may comprise an optical matrix-vector multiplier 2. An example of such a multiplier 2 is depicted in FIG. 2. In some embodiments, the multiplier 2 comprises an optical system having a first spatial light modulator (SLM) 11 and a second spatial light modulator (SLM) 12. The matrix-vector multiplication is performed by directing a beam of light 15 through the optical system. The first SLM 11 may be configured to module the phase only, the amplitude only, or the phase and the amplitude. The second SLM 12 may be configured to module the phase only, the amplitude only, or the phase and the amplitude.

Neuron values may be encoded in the electric field amplitude of light propagating through the optical system. In an embodiment, the first SLM 11 comprises a vector-modulating portion 111 that represents an input vector 21 (e.g., pixels in the vector-modulating portion 111 are controlled to modulate light in such a way as to encode values defining elements of the input vector 21). The input vector 21 is thus encoded by the vector-modulating portion 111 in the spatial field distribution of the light interacting with the first SLM 11. In an embodiment, the vector is a positive-valued vector. The first SLM 11 may comprise a one-dimensional array of pixels or a two-dimensional array of pixels. The first SLM 11 may, for example, comprise one or more of any of the following: a digital micromirror device; an acousto-optic modulator array; a mechanical modulator array; an electro-optic modulator array. When a one-dimensional array is used, the multiplier 2 may be provided with a cylindrical lens to optically fan out the light encoding the vector before the light impinges on the second SLM 12. In the example depicted in FIG. 2, the first SLM 11 comprises a digital micromirror device (DMD) (e.g., Texas Instruments DLP 6500). In this example, the DMD was an amplitude-only modulator.

In some embodiments, the second SLM 12 comprises a matrix modulating portion 121. The matrix modulating portion 121 represents the weight matrix (e.g., pixels in the matrix modulating portion 121 are controlled to modulate light according to real or complex values defining the elements of the weight matrix).

In some embodiments, the second SLM 12 comprises a liquid-crystal spatial light modulator (LC-SLM). In the example depicted in FIG. 2, the second SLM 12 comprises a liquid-crystal phase-only spatial light modulator (e.g., LC-SLM, Santec SLM 100). The matrix modulating portion 121 of the second SLM 12 encodes an arbitrary real-valued or complex-valued weight matrix. In the example shown, a phase grating pattern is applied with a local offset and height of the grating controlled to obtain the required phase and amplitude pattern in the first diffraction order.

The beam of light 15 is directed through the optical system in such a way as to be modulated by the vector-modulating portion 111 of the first SLM 11 and by the matrix-modulating portion 121 of the second SLM 12. As the light passes through the respective planes of the portions 111 and 121, each row of the weight matrix is multiplied in an element-wise fashion by the input vector. Thus, the optical system is configured such that light output from the matrix-modulating portion 121 of the second SLM 12 represents an element-wise multiplication of each row of the weight matrix by the vector. An optical arrangement down-beam of the second SLM 12 sums light from each part of the matrix-modulating portion 121 representing a respective row of the weight matrix to provide light representing a respect element of an output vector 22. In some embodiments, as exemplified in FIG. 2, the optical arrangement for performing the summing comprises a cylindrical lens 13.

An optical sensor 14 is provided for measuring the output vector 22. In some embodiments, the optical sensor 14 comprises a fast CMOS camera. In the example of FIG. 2, a fast CMOS camera was used (e.g., Basler ace acA640-750 um).

Lenses may be added to the arrangement of FIG. 2 to reduce or eliminate unwanted diffraction. This was done when obtaining the demonstration data discussed below.

In some embodiments, the output vector 22 is read out using homodyne detection. The homodyne detection may use a reference beam. In some embodiments, the summing of light to provide light representing each element of the output vector includes summing of light from the reference beam. The reference beam is directed through the optical system. The reference beam may represent a local oscillator (LO) of the homodyne detection.

It is desirable for the LO to be phase-stable with respect to the signal. The inventors have found that can achieved by allocating portions (reference regions) of the first and second SLMs (e.g. portions of active areas) to the reference beam. This allows the reference beam to follow a very similar path through the optical system as the signal beam. The portion of the beam that reflects from the reference region can serve as the LO. Both the signal and LO fields propagate through the entire system, and so the cylindrical lens not only completes the MVM, but also mixes the LO field with the MVM result at the output plane. Therefore, direct intensity measurement at the output plane completes the homodyne detection and reveals the neuron values. Since both the LO and signal share the same optical path together with all the optical elements, their relative phase barely fluctuates, and the phase offset can be conveniently set by the second SLM 12 (an LC-SLM in the example of FIG. 2). Such a homodyne detection scheme achieves considerably lower system complexity in comparison with an alternative of introducing an external LO beam and actively stabilizing the relative phase.

Thus, in some embodiments, as exemplified in FIG. 2, the first SLM 11 comprises a reference portion 112. The reference portion 112 is separate from the vector-modulating portion 111. The reference portion 112 may correspond to a portion of an active area of the first SLM 11 different to the portion of the active area of the first SLM 11 corresponding to the vector-modulating portion 111. The reference portion 112 and vector-modulating portion 111 may be non-overlapping and/or adjacent to each other. Similarly, the second SLM 12 comprises a reference portion 122. The reference portion 122 is separate from the matrix-modulating portion 121. The reference portion 122 may correspond to a portion of an active area of the second SLM 12 different to the portion of the active area of the second SLM 12 corresponding to the matrix-modulating portion 121. The reference portion 122 and matrix-modulating portion 121 may be non-overlapping and/or adjacent to each other.

The reference beam interacts with the reference portions 112, 122 of the first and second SLMs 11, 12. In some embodiments, the reference portion 112 of the first SLM 11 has a spatially uniform reflectivity. For example, the reference portion 112 may comprise a sub-array of pixels of the first SLM 11 that are all set to the same value, such as maximum reflectance. In some embodiments, the reference portion 122 of the second SLM 12 has a spatially uniform reflectivity. For example, the reference portion 122 may comprise a sub-array of pixels of the second SLM 12 that are all set to the same value, such as maximum reflectance.

The inventors demonstrated performance of the multiplier 2 of FIG. 2 by running a large number of random real-valued MVMs with matrix sizes of 100×100 and 100×25. The results are shown in FIGS. 3 and 4. The output vector 22 is normalized by the maximum possible output which is obtained when all the vector and matrix elements are at maximum. The experimentally measured data fall along the diagonal theoretical line. The root-mean-square error (RMSE) for the two matrix sizes are 0.0024 and 0.0036. These RMSE levels correspond to 8-bit precision over the full range and are at least five times better than previously achieved by the inventors.

The multiplier 2 discussed above with reference to FIG. 2 also intrinsically supports complex-valued operation. The inventors demonstrated complex-valued MVM with the matrix size of 100×10, and measured both the real and imaginary parts of the output by setting different LO phases on the second SLM 12 (implemented as an LC-SLM). FIG. 5 plots examples of the experimentally measured result on the complex plane, compared with theoretical target values. FIG. 6 shows the complex-valued MVM precision for the real and imaginary parts, and the RMSE values are 0.0034 and 0.0039, respectively.

The precise optical multiplier 2 described above with reference to FIG. 2 can form the basis of an ONN. The multiplier 2 can be configured for example to directly work as an optical linear classifier as depicted schematically in FIG. 7, referred to herein as ONN-1. To demonstrate operation of the ONN-1 configuration, the inventors performed hybrid training of ONN-1 on the MNIST handwritten digits dataset. The dataset consists of 70000 greyscale bitmaps of size 28×28. These images were downsampled to size 10×10, and then flattened into vectors to be fed to the input layer of the optical linear classifier, as depicted schematically in FIG. 2 top left. At the output layer, 10 neuron values (represent by output vector 22) are measured by the optical sensor 14 (camera) and used to calculate a digital cross-entropy loss function after applying a digital softmax activation. The target values of the output neurons were 0 or 1 dependent on the label of the bitmap (“one-hot encoding”). The entire dataset was split into training, validation and test sets, each consisting of 60000, 5000, and 5000 bitmaps. The training was implemented in 500 randomly sampled mini-batches with a mini-batch size of 240. Every 50 iterations, the validation accuracy was calculated and the system re-calibrated by running a few MVM examples and fine adjusting the parameters that map the camera grey level to MVM output.

It is desirable that the system errors do not accumulate and blow up during the hybrid training. FIG. 8 depicts the entire training process, and it is clear that the optical system maintains the precision steadily. FIG. 9 shows the learning curves during the hybrid training. It can be seen that both the loss function and validation accuracy converge quickly after the first few iterations. A learning curve of a similar digital electronic linear classifier (DENN-1) is also presented for comparison. After the hybrid training, image classification was performed on the test set, and the confusion matrix is shown in Figure FIG. 10. The classification accuracy reaches 88.0%, and DENN-1 scores 91.8%. The slightly slower convergence and lower accuracy of ONN-1 as compared to DENN-1 is mainly due to random dynamic experimental noise, as will be discussed later. During the hybrid training, the standard error backpropagation was applied without any modelling of the optical system or inclusion of noise.

The multiplier 2 is demonstrated next in a more complicated hybrid opto-electronic network, referred to herein as ONN-2 and depicted schematically in FIG. 11. ONN-2 consists of one optical input layer, one hidden layer with digital ReLU activation and one digital output layer, with 100, 25 and 10 neurons at each respective layer. Such hybrid networks may simplify the acquisition and processing of data in deep optics and IoT applications by extracting salient features from the optical front-end. FIG. 9 plots the learning curve of this ONN in comparison with a similar digital electronic network (DENN-2). FIG. 12 shows the confusion matrix of the test set for ONN-2. The test accuracy reaches 92.7%, above the benchmark level of a linear classifier. Higher accuracy can be achieved by increasing the network size. As an illustration, a larger network was simulated with 784, 256 and 10 neurons at each layer, and during the training random dynamic noise was included that matched the experimental noise level. In this case the network was found to reach 94.5% accuracy.

It has been recently observed that diffractive neural networks employing complex-valued operations can outperform linear classifiers, even though the diffractive connections are entirely linear. This is because the intensity detection at the output layer of the complex-valued ONN is equivalent to creating a hidden layer with a square nonlinearity. Consider a single-layer complex-valued optical linear classifier with real-valued inputs Et and complex-valued weights wⱼᵢ. At the output layer the intensity of each output unit is detected as follows:

$${I}_{j} = {\vert {\sum }_{i} {w}_{ji} {E}_{i} \vert}^{2} = {( {\sum }_{i} Re ( {w}_{ji} ) {E}_{i} )}^{2} + {( {\sum }_{i} Im ( {w}_{ji} ) {E}_{i} )}^{2} . \qquad ( 4 )$$

It can be see that this is equivalent to a two-layer real-valued ONN with square activation at the hidden layer, followed by a weight matrix with the fixed values of 0 and 1, connecting each output neuron to exactly two hidden neurons. This equivalence is depicted in FIG. 13.

As mentioned above, the multiplier 2 according to embodiments of the present disclosure intrinsically supports both real-valued and complex-valued operations. These properties can be exploited to build a complex-valued ONN with stronger learning capabilities. Architectures of this type are referred to herein as ONN-3.

Even though the output from architectures of the ONN-3 type is a set of intensities, complex-valued output neuron amplitudes are required in these embodiments for the calculation of the weight matrix update. In some embodiments, these amplitudes are measured by changing a relative phase ϕ between a reference beam (e.g., an LO field) and a signal beam.

Example implementations are described below with reference to FIGS. 14 and 15. FIG. 14 schematically depicts a sequence of operations performed by the architecture. A first SLM 11 (left) is used to encode an input vector 21 that represents an example input image. The first SLM 11 is a DMD in the example shown. A 2D array of pixel values defining the input image is down-sampled and flattened to allow the input image to be represented by the input vector 21 (see FIG. 2). The input vector 21 is encoded in the vector-modulating portion 111 of the first SLM 11. The first SLM 11 further comprises a reference portion 112. The reference portion 112 is uniformly reflective. Light from the first SLM 11 propagates from the first SLM 11 to a second SLM 12. Light from the vector-modulating portion 111 is directed onto a matrix-modulating portion 121 of the second SLM 12. Light from the reference portion 112 is directed onto a reference portion 122 of the second SLM 12. FIG. 15 is an enlarged view of the second SLM 12. The second SLM 12 is an LC-SLM in the example shown. An output from the second SLM 12 passes through a cylindrical lens 13 to provide an output vector 22 represented as a sequence of intensities (arranged vertically in the figure). The sequence of intensities can be read out using an optical sensor 14 (e.g., camera). As will be described below, combinations of the intensities are used to calculate values of a complex vector (i.e., a vector where each element can have non-zero real and imaginary parts).

In an embodiment, as exemplified in FIGS. 14 and 15, the complex-valued multiplication is achieved by configuring the reference portion 122 of the second SLM 12 to have a plurality of sub-portions 124 (see FIG. 15). Each sub-portion 124 is aligned with a part of the matrix-modulating portion 121 corresponding to a respective row 123 of the weight matrix (i.e., the sub-portions 124 are aligned with the respective rows 123 along the long axes of the rows, as exemplified in FIG. 15). As exemplified in FIG. 15, each sub-portion 124 may have substantially the same size 125 (see double ended arrow) as the part of the matrix-modulating portion 121 corresponding to a respective row in a direction perpendicular to the long axis of the row. In some embodiments, as exemplified in FIGS. 14 and 15, the sub-regions 124a-d are elongate regions aligned with parts 123 of the matrix-modulating portion 121 corresponding to respective rows of the weight matrix and positioned adjacent to each other in the direction perpendicular to the parts 123 of the matrix-modulating portion 121 corresponding to respective rows of the weight matrix (i.e. in a direction perpendicular to the long axes of the rows).

Each sub-portion 124 comprises a plurality of sub-regions 124a-d. In the example of FIGS. 14 and 15, each sub-portion 124 comprises four sub-regions 124a-d. Each sub-region 124a-d is configured to apply a different phase offset to light interacting with the sub-region 124a-d. The sub-regions 124a-d are positioned such that the optical arrangement (cylindrical lens 13) sums light from each of the sub-regions 124a-d separately from each other to thereby provide a respective plurality of phase-signals corresponding to each row of the weight matrix. In the example shown, four phase-signals are provided for each row, one phase-signal for each of the four sub-regions 124a-d. Each plurality of phase-signals corresponding to a row of the weight matrix produces a corresponding plurality of intensities 24 (see example labelled in FIG. 14). The intensities 24 are used to calculate (e.g., using a suitable programmed computer 26 receiving input from an optical sensor 14 measuring the intensities 24) the real and imaginary parts of a respective element 25 of a complex vector 23 representing a result of the matrix-vector multiplication. For example, the following may be performed for each element 25 of the complex vector 23: 1) use intensities of at least two (e.g. two) of the phase-signals corresponding to a respective row of the weight matrix to extract a real component of the element; and 2) use intensities of a different at least two (e.g. a different two) of the phase-signals corresponding to the respective row to extract an imaginary component of the element. In the example shown, each set of four sub-regions 124a-d are configured to apply respective phase offsets ϕ of ϕ, 0 π/2, π, 3π/2 (from top to bottom within each sub-portion 124). Each real component of an element 25 of the complex vector 23 is calculated by subtracting intensities corresponding to ϕ=0 and ϕ=π. Each imaginary component of the element 25 is calculated by subtracting intensities corresponding to ϕ=π/2 and ϕ=3π/2.

Thus, a methodology is provided which allows the real and imaginary parts of the output to obtained from a single camera frame. Upon readout, the modulus square activation can be computed digitally. To complete the hybrid training, digital error backpropagation can be run with the optically performed linear stage modelled as an equivalent two-layer real-valued neural network.

FIG. 16 shows a learning curve derived from an example implementation corresponding to FIGS. 14 and 15. FIG. 17 shows the confusion matrix of the test set for ONN-3. The learning curve converges quickly, with the highest classification accuracy of 93.6% achieved with the validation set, and 92.6% with the test set. The inventors also carried out in silico training and performed intensity measurement directly by switching off the LO field. In this case a classification accuracy of 92.2% was obtained with the test set.

### Impact of Noise

The inventors have demonstrated the efficacy of the hybrid training scheme with three different types of ONNs, as summarized in the Table I below.

TABLE I
(List of ONNs demonstrated in this work):

| | | | Hybrid | |
|---|---|---|---|---|
| | Non- | Network | training | DENN |
| ONN type | linearity | size | accuracy | accuracy |
| Optical linear | None | 100 × 10 | 88.0% | 91.8% |
| classifier (ONN-1) | | | | |
| Hybrid opto- | ReLU | 100 × 25 × 10 | 92.7% | 95.7% |
| electronic | | | | |
| network (ONN-2) | | | | |
| Complex-valued | Modulus | 100 × 10 | 92.6% | 94.8% |
| ONN (ONN-3) | square | | | |

ONN-1 was additionally used to explore the performance of hybrid training compared to traditional in silico training in different noisy environments, as described below.

In order to systematically compare different types of noise, the inventors started with a well-controlled, low-noise environment. After carefully calibrating the system and performing the in silico training, ONN-1 was found to reach 87.7% classification accuracy, nearly the same as that of the hybrid training. This indicates that most of the aberrations and systematic errors have been eliminated, which is consistent with the small RMSE of the optical multiplier.

In the comparative study, different imperfections were introduced to the optical setup via the second SLM 12 (LC-SLM), and the results are listed in Table II.

TABLE II
(Comparison of hybrid training and in silico training
in presence of experimental imperfection):

| | Hybrid | in silico | |
|---|---|---|---|
| | training | training | DENN |
| No additional noise | 88.0% | 87.7% | 91.8% |
| 10% static additive noise | 87.6% | 78.0% | 91.8% |
| 20% static additive noise | 86.5% | 72.8% | 91.8% |
| 20% static multiplicative noise | 88.1% | 87.5% | 91.8% |
| 50% static multiplicative noise | 85.2% | 80.6% | 91.8% |
| 20% dynamic additive noise | 79.5% | 76.8% | 81.7% |
| 30% dynamic additive noise | 69.2% | 69.5% | 79.7% |

The first imperfection is static additive noise: a random bias wᵢⱼ←wⱼᵢ+ϵⱼᵢ, ϵ ∈ N(O, σ) applied to each weight matrix element, which remains unchanged during the training and testing. This can arise from ambient light, imprecise device calibration, etc. In this experiment, the bias, which is fixed during the entire training and testing process, was randomly sampled. As seen from the second and third rows of Table II, hybrid training is robust to such static additive noise, while the accuracy of in silico training drops to 72.8% at 20% noise level. The noise level is defined as the standard deviation σ normalized by the signal standard deviation.

A second common imperfection is static multiplicative noise wⱼᵢ←wⱼᵢ×ηⱼᵢ, η ∈ N(1, σ). This may be caused by non-uniform transmission of different optical channels, imperfect interference, different responses of photodetectors, etc. From Table II, it is seen that hybrid training is also robust against such noise, while the performance of in-silico training degrades to 80.6% at 50% noise level, where the noise level is indicated by the noise standard deviation σ.

The last major type of imperfection is dynamic noise, which fluctuates over time. This may arise from imprecise device calibration, environmental fluctuation, etc. In the experiment the dynamic noise was modelled by additive noise (as defined above) applied to each weight element, which is randomly re-sampled at each weight update. Our results show that the ONN trained in either the hybrid or in silico scheme is sensitive to such random dynamic noise, and the accuracy drops to about 69% at 30% noise level, i.e. at the same level as an equivalent DENN.

Optical Calculation of Error Vector There is a long-standing challenge to implement all-optical ONN training, such that the error terms are calculated and backpropagated optically. Embodiments of the present disclosure can be adapted to demonstrate an important step towards realising this goal. To this end, the categorical cross-entropy loss function in an implentation of ONN-1 is replaced with a mean-squared error (MSE) loss function,

$$ℒ = \frac{1}{2} {( {z}_{j}^{( 1 )} - {y}_{j} )}^{2} \qquad ( 5 )$$

where zⱼ⁽¹⁾ is the output of the linear network and yⱼ is the corresponding one-hot encoded label. With this network architecture, the error vector to be calculated is

$${δ}_{j} = {z}_{j}^{( 1 )} - {y}_{j} \qquad ( 6 )$$

This is possible to implement optically by destructive interference between the ONN output and an optically-encoded label. An example implementation is depicted schematically in FIG. 18. The implementation involves adapting the first and second SLMs 11 and 12 to introduce a label region (a further active region) on both the first and second SLMs 11 and 12 (e.g., on a DMD and LC-SLM respectively). In FIG. 18, an example label region on the first SLM 11 is labelled 113 and an example label region on the second SLM 12 is labelled 123.

During hybrid training, in addition to encoding the input vector 21, the target label is encoded on the first SLM 11 (e.g., DMD), and the label region 123 on the second SLM 12 (e.g., LC-SLM) is set to maximum reflection, with a rc phase shift relative to the reference region 122. After passing through the cylindrical lens 13, the label destructively interferes with both the signal and LO fields at the output plane. Intensity measurement therefore directly yields the error term (6). This optically-calculated error is then processed digitally to update the weights.

In this hybrid training setting the inventors achieved a peak validation accuracy of 83.3%. An inference was then performed on the test set by switching off the label region and measuring only the network output. An accuracy of 83.4% was achieved. By comparison, simulating this ONN with a DENN of the same architecture and MSE loss function, yielded a test accuracy of 85.7%. The lower accuracy as compared to that of ONN-1 or DENN-1 is because the MSE loss function is not best suited to this classification task, compared to the categorical cross-entropy. This accuracy level can be significantly improved by introducing a nonlinear activation layer.

### Example Hardware Configurations

The LC-SLM model used in the above demonstrations has a resolution of 1440×1050, of which 1140×1050 pixels were used as the signal and 300×1050 pixels as the reference region. A diagonal blazed grating was used with horizontal and vertical periods of 10 pixels, such that the maximum matrix size was about 110×100. Larger network size can be achieved by using LC-SLM models with higher resolution and reducing the grating period.

During the hybrid training, computation speed may be limited by the frame rates of the SLMs 11 and 12 (e.g., DMD, LC-SLM) and/or the optical sensor 14 (e.g., camera). In the above demonstrations, the DMD implementing the first SLM 11 worked at 1440 Hz frame rate, while the camera worked at a maximum frame rate of 1480 Hz. The second SLM 12 (e.g., LC-SLM) only needs to update once per mini-batch, i.e. at 6 Hz for a mini-batch size of 240 images. Therefore its maximum operational refresh rate of 60 Hz supports up to 14.4 kHz DMD frame rate with this mini-batch size. Therefore, the system frame rate is limited by the DMD at 1440 Hz, and the computation speed is 1440×100×25×2=7.2×10⁶ operations per second (where 100×25 are the first ONN layer dimensions). Today's advanced DMD and LC-SLM models support a maximum frame rate of up to 20 kHz and 1 kHz respectively, and one can replace the camera by an ultra-fast photodetector array. Therefore, the system frame rate can be increased by at least 10 times. Assuming a two-layer ONN with 1000 neurons per layer that updates at 20 kHz, the computation speed would be 8×10¹⁰ operations per second. Although ONNs with similar or even higher computing rates have been demonstrated elsewhere, these demonstrations are limited to convolutional architectures. In contrast, ONNs of the present disclosure are fully connected, and in this domain, to the inventors' knowledge, have the largest layer sizes demonstrated to date and are the only ones capable of rapid update.

The present disclosure thus shows that analog systems with limited signal-to-noise ratio can still be physically trained to reach high performance, and this is a crucial step towards the more advanced goal of all-optical training of neural networks. A further step is demonstrated towards this goal by modifying ONNs to allow optical calculation of the error vector.

1. A method of training a neural network, comprising:
performing a forward propagation of information through the neural network; and
performing an error backpropagation to update parameters defining the neural network, wherein:
a mathematically linear stage of the forward propagation is performed optically.

2. The method of claim 1, wherein at least a portion of the error backpropagation is performed digitally using a computer.

3. The method of claim 1, wherein the optically performed linear stage of the forward propagation comprises a matrix-vector multiplication representing interconnection of neurons in different layers of the neural network.

4. The method of claim 3, wherein the matrix-vector multiplication comprises multiplying a vector by a matrix, wherein the vector represents values of neurons in one layer of the neural network and the matrix represents a weight matrix defining weights associated with interconnections with another layer in the neural network, the weights forming at least a portion of the parameters to be updated by the error backpropagation.

5. The method of claim 4, wherein the matrix-vector multiplication is performed by directing a beam of light through an optical system comprising a first spatial light modulator and a second spatial light modulator.

6. The method of claim 5, wherein:
the first spatial light modulator is controlled to provide a vector-modulating portion that represents the vector;
the second spatial light modulator is controlled to provide a matrix-modulating portion that represents the weight matrix; and
the beam of light is directed through the optical system in such a way as to be modulated by the vector-modulating portion of the first spatial light modulator and by the matrix-modulating portion of the second spatial light modulator.

7. The method of claim 6, wherein the first spatial light modulator comprises a one-dimensional or two-dimensional array.

8. The method of claim 6, wherein each of the first spatial light modulator and the second light modulator comprises one or more of the following: a digital micromirror device; an acousto-optic modulator array; a mechanical modulator array; an electro-optic modulator array.

9. The method of claim 6, wherein each of the first spatial light modulator and the second spatial light modulator is configured to modulate the phase only, the amplitude only, or the phase and the amplitude.

10. The method of claim 6, wherein the second spatial light modulator comprises a liquid-crystal spatial light modulator, preferably a liquid-crystal phase-only spatial light modulator.

11. The method of claim 6, wherein the optical system is configured such that light output from the matrix-modulating portion of the second spatial light modulator represents an element-wise multiplication of each row of the weight matrix by the vector.

12. The method of claim 6, wherein an optical arrangement down-beam of the second spatial light modulator sums light from each part of the matrix-modulating portion representing a respective row of the weight matrix to provide light representing a respective element of an output vector.

13. The method of claim 12, wherein the optical arrangement comprises a cylindrical lens.

14. The method of claim 12, comprising reading out the output vector using homodyne detection.

15. The method of claim 12, wherein the summing of light to provide light representing each element of the output vector includes summing of light from a reference beam that is directed through the optical system.

16. The method of claim 15, wherein:
the first spatial light modulator is configured and/or controlled to provide a reference portion separate from the vector-modulating portion;
the second spatial light modulator is configured and/or controlled to provide a reference portion separate from the matrix-modulating portion; and
the reference beam interacts with the reference portions of the first and second spatial light modulators.

17. The method of claim 16, wherein the reference portion of the first spatial light modulator has a spatially uniform reflectivity.

18. The method of claim 16, wherein the reference portion of the second spatial light modulator has a spatially uniform reflectivity.

19. The method of claim 16, wherein:
the reference portion of the second spatial light modulator has a plurality of sub-portions, each sub-portion aligned with a part of the matrix-modulating portion corresponding to a respective row of the weight matrix; and
each sub-portion comprises a plurality of sub-regions, each sub-region configured to apply a different phase offset to light interacting with the sub-region.

20. The method of claim 19, wherein the sub-regions are positioned such that the optical arrangement sums light from each of the sub-regions separately from each other to thereby provide a respective plurality of phase-signals corresponding to each row of the weight matrix.

21. The method of claim 20, wherein the sub-regions are elongate regions aligned with parts of the matrix-modulating portion corresponding to respective rows of the weight matrix and positioned adjacent to each other in the direction perpendicular to the row directions of the parts of the matrix-modulating portion corresponding to respective rows of the weight matrix.

22. The method of claim 20, wherein each plurality of phase-signals corresponding to a row of the weight matrix produces a corresponding plurality of intensities and the method comprises using those intensities to calculate the real and imaginary parts of a respective element of a complex vector representing a result of the matrix-vector multiplication.

23. The method of claim 22, wherein for each element of the complex vector:
intensities of at least two of the phase-signals corresponding to a respective row of the weight matrix are used to extract a real component of the element; and
intensities of a different at least two of the phase-signals corresponding to the respective row of the weight matrix are used to extract an imaginary component of the element.

24. The method of claim 19, wherein the error backpropagation is performed digitally by modelling the optically performed linear stage as an equivalent two-layer real-valued neural network.

25. The method of claim 1, wherein a non-linear stage of the forward propagation is performed digitally using a computer.

26. The method of claim 25, wherein the non-linear stage comprises any one or more of the following: a Rectified Linear Unit; a Leaky Rectified Linear Unit; an Exponential Linear Unit; a sigmoid activation function; a tanh activation function; a modulus squared activation function.

27. The method of claim 1, wherein a further linear stage and/or non-linear stage of the forward propagation is/are performed digitally using a computer.

28. An apparatus for training a neural network, comprising:
a data processing system representing the neural network, whereinthe data processing system is configured to:
perform a forward propagation of information through the neural network; and
perform an error backpropagation to update parameters defining the neural network; and
the data processing system includes an optical data processing unit configured to perform at least a mathematically linear stage of the forward propagation.

29. The apparatus of claim 28, wherein the data processing system is configured such that at least a portion of the error backpropagation is performed digitally using a computer.

30. The apparatus of claim 28, wherein the optical data processing unit comprises an optical matrix-vector multiplier representing interconnection of neurons in different layers of the neural network.

31. The apparatus of claim 30, wherein the vector represents values of neurons in one layer of the neural network and the matrix represents a weight matrix defining weights associated with interconnections with another layer in the neural network, the weights forming at least a portion of the parameters to be updated by the error backpropagation.

32. The apparatus of claim 31, wherein the matrix-vector multiplier comprises an optical system having a first spatial light modulator and a second spatial light modulator and the matrix-vector multiplier is configured to perform the matrix-vector multiplication by directing a beam of light through the optical system.

33. The apparatus of claim 32, wherein the matrix-vector multiplier is configured to:
control the first spatial light modulator to provide a vector-modulating portion that represents the vector;
control the second spatial light modulator to provide a matrix-modulating portion that represents the weight matrix; and
direct the beam of light through the optical system in such a way as to be modulated by the vector-modulating portion of the first spatial light modulator and by the matrix-modulating portion of the second spatial light modulator.

34. The apparatus of claim 33, wherein the first spatial light modulator comprises a one-dimensional or two-dimensional array.

35. The apparatus of claim 33, wherein each of the first spatial light modulator and the second light modulator comprises one or more of the following: a digital micromirror device; an acousto-optic modulator array; a mechanical modulator array; an electro-optic modulator array.

36. The apparatus of claim 33, wherein each of the first spatial light modulator and the second spatial light modulator is configured to modulate the phase only, the amplitude only, or the phase and the amplitude.

37. The apparatus of claim 33, wherein the second spatial light modulator comprises a liquid-crystal spatial light modulator, preferably a liquid-crystal phase-only spatial light modulator.

38. The apparatus of claim 33, wherein the optical system is configured such that light output from the matrix-modulating portion of the second spatial light modulator represents an element-wise multiplication of each row of the weight matrix by the vector.

39. The apparatus of claim 33, wherein the matrix-vector multiplier comprises an optical arrangement down-beam of the second spatial light modulator that is configured to sum light from each part of the matrix-modulating portion representing a respective row of the weight matrix to provide light representing a respective element of an output vector.

40. The apparatus of claim 39, wherein the optical arrangement comprises a cylindrical lens.

41. The apparatus of claim 39, wherein the matrix-vector multiplier is configured to read out the output vector using homodyne detection.

42. The apparatus of claim 39, wherein the matrix-vector multiplier is configured to direct light from a reference beam through the optical system and such that the summing of light to provide light representing each element of the output vector includes summing of light from the reference beam.

43. The apparatus of claim 42, wherein the matrix-vector multiplier is configured such that:
the first spatial light modulator is configured and/or controlled to provide a reference portion separate from the vector-modulating portion;
the second spatial light modulator is configured and/or controlled to provide a reference portion separate from the matrix-modulating portion; and
the reference beam interacts with the reference portions of the first and second spatial light modulators.

44. The apparatus of claim 43, wherein the reference portion of the first spatial light modulator has a spatially uniform reflectivity.

45. The apparatus of claim 43, wherein the reference portion of the second spatial light modulator has a spatially uniform reflectivity.

46. The apparatus of claim 43, wherein:
the reference portion of the second spatial light modulator has a plurality of sub-portions, each sub-portion aligned with a part of the matrix-modulating portion corresponding to a respective row of the weight matrix; and
each sub-portion comprises a plurality of sub-regions, each sub-region configured to apply a different phase offset to light interacting with the sub-region.

47. The apparatus of claim 46, wherein the sub-regions are positioned such that the optical arrangement sums light from each of the sub-regions separately from each other to thereby provide a respective plurality of phase-signals corresponding to each row of the weight matrix.

48. The apparatus of claim 47, wherein the sub-regions are elongate regions aligned with parts of the matrix-modulating portion corresponding to respective rows of the weight matrix and positioned adjacent to each other in the direction perpendicular to the row directions of the parts of the matrix-modulating portion corresponding to respective rows of the weight matrix.

49. The apparatus of claim 47, wherein:
the matrix-vector multiplier is configured such that each plurality of phase-signals corresponding to a row of the weight matrix produces a corresponding plurality of intensities; and
the apparatus is configured to use those intensities to calculate the real and imaginary parts of a respective element of a complex vector representing a result of the matrix-vector multiplication.

50. The apparatus of claim 49, configured such that for each element of the complex vector:
intensities of at least two of the phase-signals corresponding to a respective row of the weight matrix are used to extract a real component of the element; and
intensities of a different at least two of the phase-signals corresponding to the respective row of the weight matrix are used to extract an imaginary component of the element.

51. The apparatus of claim 46, wherein the data processing system is configured to perform the error backpropagation digitally by modelling the optically performed linear stage as an equivalent two-layer real-valued neural network.

52. The apparatus of claim 28, configured to perform a non-linear stage of the forward propagation digitally using a computer.

53. The apparatus of claim 52, wherein the non-linear stage comprises any one or more of the following: a Rectified Linear Unit; a Leaky Rectified Linear Unit; an Exponential Linear Unit; a sigmoid activation function; a tanh activation function; a modulus squared activation function.
